(19) United States
(12) Patent Application Publication
(10) Pub. No.: US 2010/0028842 A1
(43) Pub. Date: Feb. 4, 2010

(54) Interactive Learning Toy

(76) Inventor: Shu-Chuan CHIU, Hsinchu City (TW)

Correspondence Address: Dr. BANGER SHIA, 102 Lindencrest Ct., Sugar Land, TX, 77479-5201, US

(21) Appl. No.: 12/418,604

(22) Filed: Apr. 5, 2009

(30) Foreign Application Priority Data
Jul. 29, 2008 (TW) 097213421

(51) Int. Cl. G09B 5/00; A63H 3/28

(52) U.S. Cl. 434/309; 446/297

(57) ABSTRACT

An interactive learning toy comprises: a main portion including a sensing and sound-emitting device, and plural sensed devices. The sensing and sound-emitting device includes a center processor unit connected to a speaker, a power, a memory, a sensor and a switch. The respective sensed devices include a memory and a sensor. By such arrangements, the interactive learning toy can emit different sounds when different sensed devices are attached to the main portion to improve the game and learning interest. In addition, the sensed devices can be designed in different forms corresponding to the passive audio data pre-recorded in the memory of the main portion to create a connection between the vision and audition to improve the learning effect and game interest.

### BACKGROUND OF THE INVENTION

1. Field of the Invention

The present invention relates to an interactive learning toy; and more particularly to an interactive learning toy which can cooperate with different fittings to produce different sounds with different tunes, timbres and volume levels to increase game and learning interests.

2. Description of the Prior Art

There is a variety of sounding toys in the present market, and sounding toys normally include a fixed type sounding toys and a random type sounding toys, wherein the fixed type sounding toys can emit the pre-stored sound when the switch is turned on or a read integrated circuit (read IC) is activated, and the random type sound-emitting toys can emit a randomly-selected sound when being touched or its read IC is activated. Hence, almost all the sounding toys emit a sound in a definite mode such as circulation mode or fixed order mode. Such sounding toys are quite novel to children at the beginning, but after a period of time, the children will lose their interest in the above sounding toys.

The present invention has arisen to mitigate and/or obviate the afore-described disadvantages.

### SUMMARY OF THE INVENTION

The primary objective of the present invention is to provide an interactive learning toy, which can satisfy the interactive requirements in learning and game.

In order to achieve the above objective, an interactive learning toy in accordance with the present invention comprises a main portion in which a center processor unit cooperates with a power, a speaker and an active audio data in a memory to produce an active audio. The main portion further interiorly includes a read IC to interact with a sensed element in the form of a tag IC that is located outside the main portion, so that the main portion can emit different sounds according to different sensed devices, thus satisfying the interactive requirements in learning and game.

### BRIEF DESCRIPTION OF THE DRAWINGS

FIG. 1 is a plane view of an interactive learning toy in accordance with the present invention;

FIG. 2 is a block diagram of the interactive learning toy in accordance with the present invention;

FIG. 3 is a block diagram illustrating a sensing sounding device interacts with a sensed device;

FIG. 4A is a plane view of a first sensed device in accordance with the present invention;

FIG. 4B is a plane view of a second sensed device in accordance with the present invention;

FIG. 4C is a plane view of a third sensed device in accordance with the present invention;

FIG. 5 is a plane view illustrating that the interactive learning toy in accordance with the present invention cooperates with an object group;

FIG. 6 is a plane view illustrating that the interactive learning toy in accordance with the present invention moves linearly and cooperates with a movement sensor to produce sounds;

FIG. 7 is plane view illustrating that the interactive learning toy in accordance with the present invention rotates 90 degrees and 180 degrees; and

FIG. 8 is a plane view illustrating that the interactive learning toy in accordance with the present invention rotates 360 degrees.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

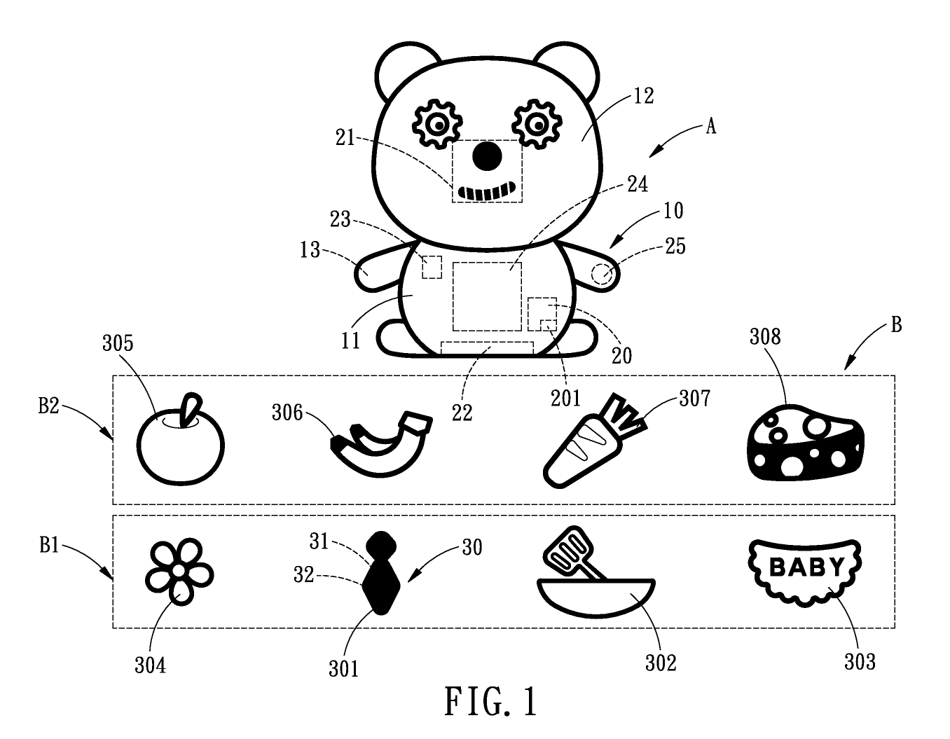

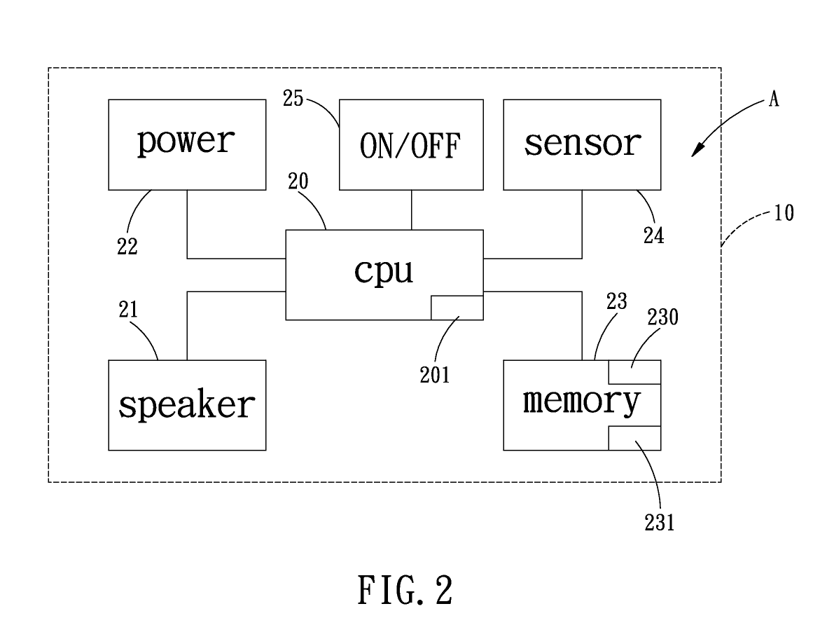

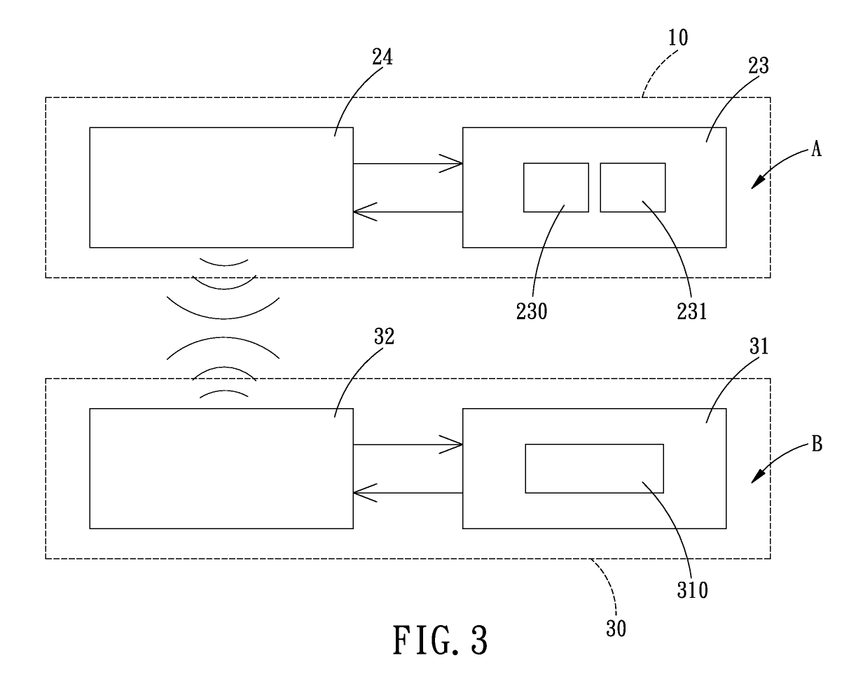

Referring to FIGS. 1-2, an interactive learning toy in accordance with a preferred embodiment of the present invention comprises a main portion 10. The main portion 10 is in the form of a doll in the present embodiment and includes a body 11 and a head 12. The body 11 is provided with plural limbs 13 at both sides thereof as desired. The interactive learning toy in accordance with the present invention is characterized in that: the overall structure includes an inner sensing and sound-emitting device A to interact with a plurality of external sensed devices B.

The sensing and sound-emitting device A essentially includes a center processing unit 20 which is externally connected to a speaker 21, a power 22, a memory 23, a sensor 24 and a switch 25.

The center processor unit 20 is a microprocessor. Besides the capability of processing audio signals, the center processor unit 20 can also sense the changing of the moving direction and manner of the main portion 10 due to connection to a motion sensor 201. Since the motion sensor 201 is not the key feature of the present invention, its detailed structure is not described herein. The center processor unit 20 can be disposed inside the body 11 of the main portion 10.

The speaker 21 is a sounding structure, for example, a horn. The speaker 21 can be disposed inside the head 12 of the main portion 10.

The power 22 is employed to supply power to all the components of the sensing and sound-emitting device A and can be a common accumulator or a rechargeable battery. The power 22 can be disposed in the body 11 or other center-of-gravity positions of the main portion 10.

The memory 23 is a common computer memory, namely a memory for storing data. The memory 23 includes an active audio database 230 and a passive database 231. The active audio database 230 is pre-recorded with plural sets of data of the sound emitted when the main portion 10 moves in terms of tone, timbre, and volume. The passive audio database 231 is pre-recorded with various passive audio data corresponding to the respective sensed devices B to cooperate with the center processor unit 20 and the motion sensor 201, so that the audio signal which has been processed by the center processor unit 20 can vary to emit various sounds. The memory 23 can be disposed inside the body 11 of the main portion 10 and other positions which are impossibly damaged by external force.

The sensor 24 is a common antenna, namely a common read IC, which can transmit and receive the audio data synchronously. The sensor 24 can be disposed on the front or back surface of the body 11, the head 12 or the limbs 13 of the main portion 10 to transmit and receive the radio signals.

The switch 25 is a common ON/OFF switch and disposed on one of the limbs 13 of the main portion 10 so as to be pressed by the user to turn on/off the overall system.

The system of the main portion 10 cooperating with the sensing and sound-emitting device A can further cooperate with the sensed devices B outside the main portion 10 to satisfy the requirements of emitting various sounds. The sensed devices B can be in an arbitrary form such as having the profiles as shown in the FIG. 1. The respective sensed devices B interiorly include a sensed element 30 which is further interiorly provided with a memory 31 and a sensor 32. The sensed element 30 is commonly called a tag IC. The memory 31 is a common memory and interiorly includes a database 310. The database 310 records profile identification data or additional audio data corresponding to the respective sensed devices B. The sensor 32 is an antenna. The sensor 32 is connected to the memory 31, so that the sensed element 30 will be powered on when it is sensed and activated by the sensor 24 of the sensing and sound-emitting device A, and then the pre-recorded identification data in the database 310 of the memory 31 of the sensed element 30 will be transmitted to the sensor 24 by the sensor 32 and processed by the center processor unit 20, after that the corresponding audio data will be selected from the active audio database 230 and the passive audio database 231 and mixed and finally played by the speaker 21. For example, corresponding sound in English, Chinese or other languages will be produced by the speaker 21 when the sensed devices B in the form of different fruits are attached to the main portion 10.

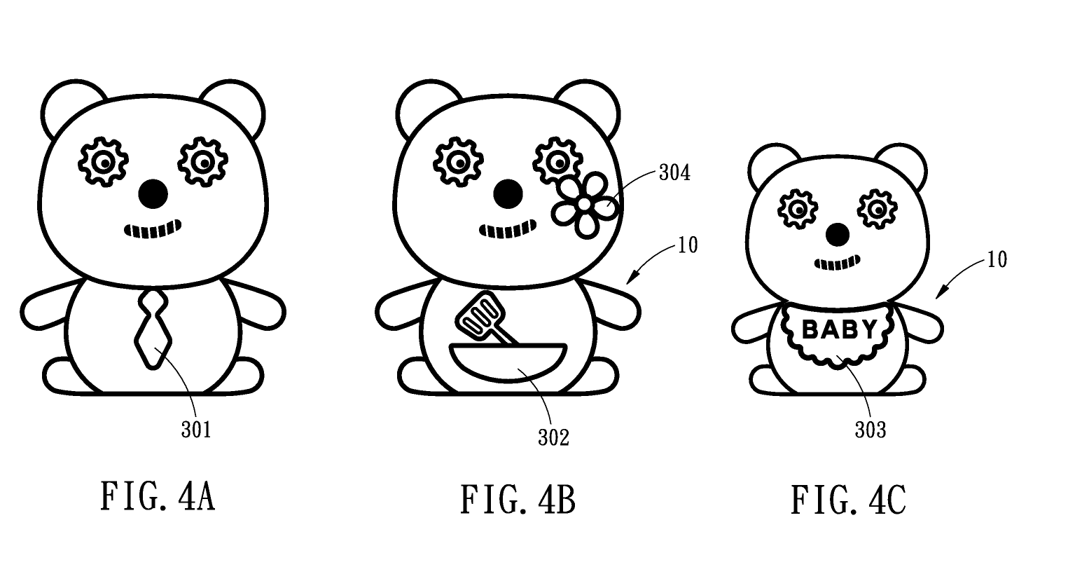

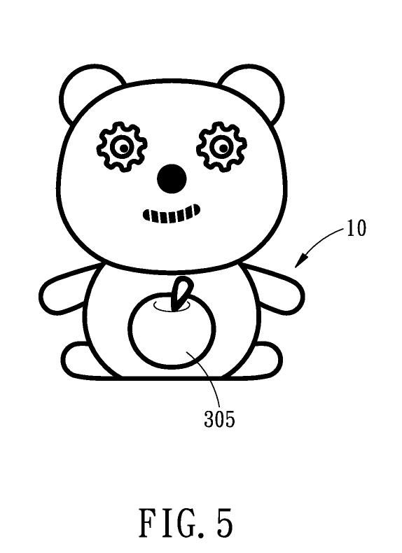

As shown in FIG. 1, the sensed devices B are divided into a timbre group B1 and an object group B2. In the present embodiment, the timbre group B1 can change the timbre of the sound emitted by the present invention and includes a father device 301, a mother device 302, a baby device 303 and a girl device 304 that represent different timbres for example, the father device 301 represent the father timbre, and the object group B2 includes an apple device 305, a banana device 306, a carrot device 307 and a cake device 308, etc. As shown in FIG. 4A, when the father device 301 is magnetically attracted to the sensor 24 of the main portion 10, the main portion 10 of the present invention will emit an adult man sound. As shown in FIG. 4B, when the mother device 302 and the girl device 304 are synchronously magnetically attracted to the main portion 10, the main portion 10 will emit a sound emitted by a person between woman and girl. Further as shown in FIG. 4C, when the baby device 303 is disposed on the main portion 10, the main portion 10 will emit a baby sound. As shown in FIG. 5, when the apple device 305 is attached to the body 11 of the main portion 10, the main portion 10 will emit the sounds with respect to the apple, such as sounding apple in English or Chinese, or other audio data.

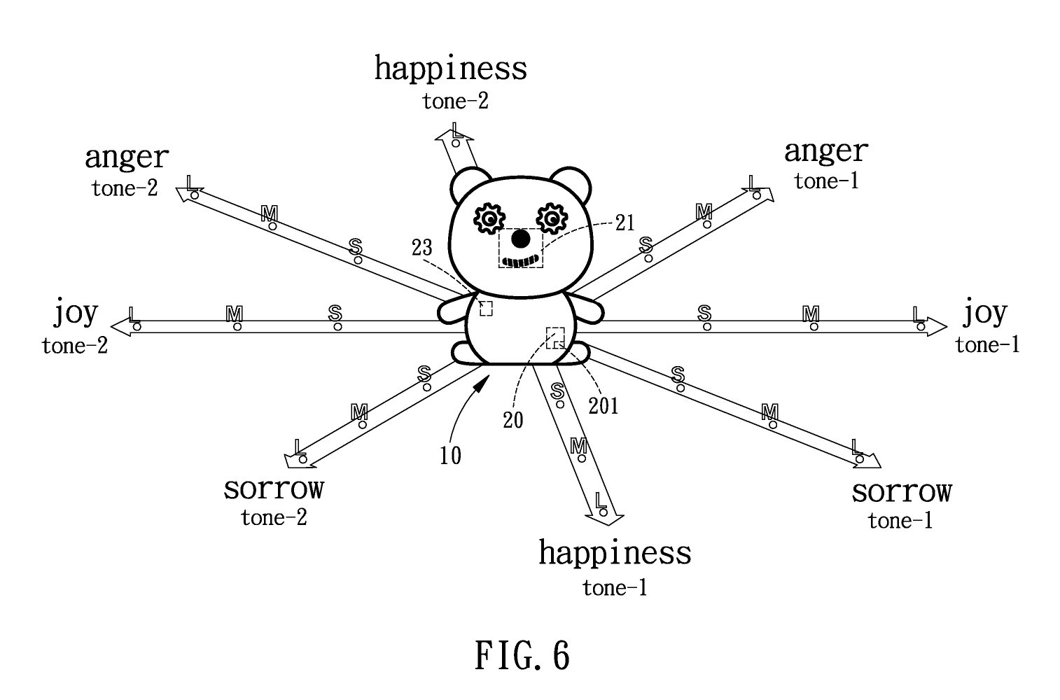

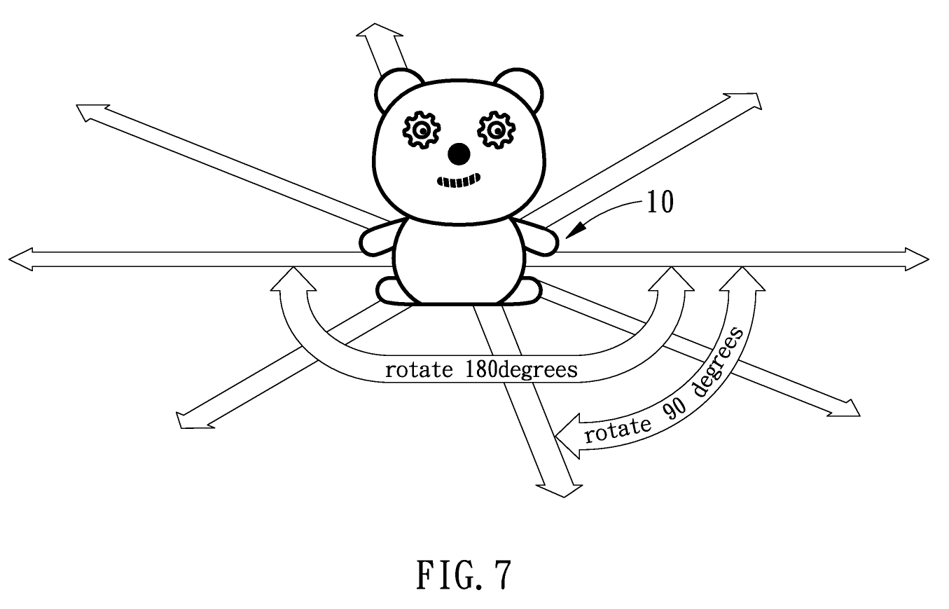

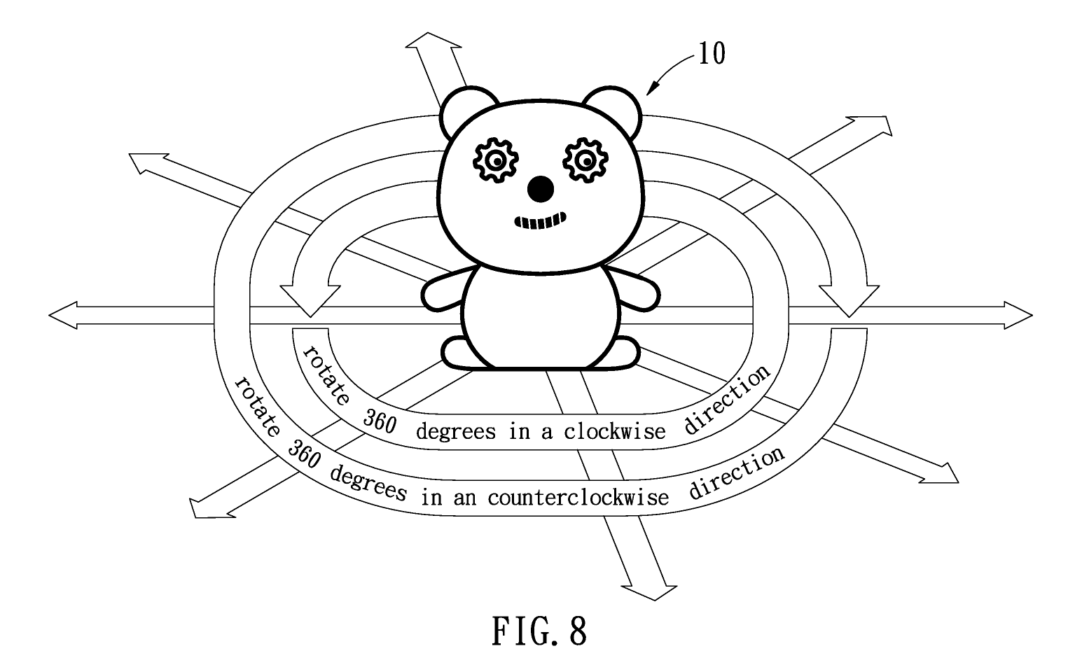

The main portion 10 of the present invention interiorly includes the center processor unit 20 of the sensing and sound-emitting device A, and the center processor unit 20 interiorly includes a motion sensor 201, so that the present invention can change the moving manner to change the volume and timbre. As shown in FIG. 6, the motion sensor 201 provided on the center processor unit 20 in the main portion 10 can cooperate with the active audio database 230 in the memory 23 to emit the corresponding tones such as happiness, anger, sorrow and joy due to the changing of the motion in direction and emit the sounds of different volume levels with the moving distance and speed changing. The interactive learning toy of the present invention can rotate 90 degrees and 180 degrees at its original place as shown in FIG. 7, or rotate 360 degrees in a clockwise or counterclockwise direction at its original place as shown in FIG. 8 to turn on/off different tones. The motion sensor 201 can control the above motions.

Furthermore, the main portion 10 of the interactive learning toy of the present invention can be in other forms such as a teaching tool and not limited to the doll of the above embodiment.

While we have shown and described various embodiments in accordance with the present invention, it is clear to those skilled in the art that further embodiments may be made without departing from the scope of the present invention.

What is claimed is:

1. An interactive learning toy comprising: a main portion including a sensing and sound-emitting device, and plural sensed devices; wherein:
the sensing and sound-emitting device includes a center processor unit connected to a speaker, a power, a memory, a sensor and a switch, wherein the center processor unit is a unit for processing audio data, the speaker is a sounding structure, the power is employed to supply power to the sensing and sound-emitting device, the memory is employed to store data, and the sensor is employed to synchronously transmit and receive audio radio data;
the respective sensed devices include a memory and a sensor, wherein the memory of the respective sensed devices includes a database for pre-recording identification data with respect to sensed device profile meanings, the sensors of the sensed devices are connected to the memories of the respective sensed devices, so that the respective sensed devices will be powered on when it is sensed and activated by the sensor of the sensing and sound-emitting device, and then a corresponding data in the database of the memory of the sensed device will be transmitted to the sensor of the sensing and sounding-emitting device by the sensor of the sensed device and then processed by the center processor unit and finally played by the speaker.

2. The interactive learning toy as claimed in claim 1, wherein the center processor unit is a microprocessor and connected to a motion sensor to sense a moving direction and manner changing of the main portion.

3. The interactive learning toy as claimed in claim 1, wherein the speaker is a horn.

4. The interactive learning toy as claimed in claim 1, wherein the power is a common accumulator or a rechargeable battery.

5. The interactive learning toy as claimed in claim 1, wherein the memory of the sensing and sound-emitting device is a computer memory and includes an active audio database which is prerecorded with plural sets of data of a sound emitted when the main portion moves in terms of tone, timbre and volume.

6. The interactive learning toy as claimed in claim 1, wherein the memory of the sensing and sound-emitting device is a computer memory and includes a passive audio database, the passive audio database is pre-recorded with plural sets of data corresponding to the respective sensed devices in terms of tone, timbre and volume.

7. The interactive learning toy as claimed in claim 1, wherein the memory of the respective sensed devices is a computer memory and includes a passive audio database, the passive audio database is pre-recorded with plural sets of data corresponding to the respective sensed devices in terms of tone, timbre and volume.

8. The interactive learning toy as claimed in claim 1, wherein the sensor is an antenna, the sensor is disposed on a front or a back surface of the main portion.

9. The interactive learning toy as claimed in claim 1, wherein the main portion is further provided with an ON/OFF switch.

10. The interactive learning toy as claimed in claim 1, wherein the sensed devices are divided into a timbre group and an object group, the timbre group includes a father device, a mother device, a baby device and a girl device that represent different timbres, the object group includes an apple device, a banana device, a carrot device and a cake device.

11. An interactive learning toy comprising: a main portion including a sensing and sound-emitting device, and plural sensed devices; wherein:
the sensing and sound-emitting device includes a center processor unit connected to a speaker, a power, a memory, a sensor and a switch, wherein the center processor unit is a unit for processing audio data and connected to a motion sensor, the speaker is a sounding structure, the power is employed to supply power to the sensing and sound-emitting device, the memory is employed to store data, and the sensor is employed to synchronously transmit and receive audio radio data;
the respective sensed devices include a sensor, the respective sensed devices will be powered on when it is sensed and activated by the sensor of the sensing and sound-emitting device to transmit a corresponding data to the sensor of the sensing and sounding-emitting device, and then the corresponding data will be processed by the center processor unit and finally played by the speaker.

12. The interactive learning toy as claimed in claim 11, wherein the speaker is a horn.

13. The interactive learning toy as claimed in claim 11, wherein the power is a common accumulator or a rechargeable battery.

14. The interactive learning toy as claimed in claim 1I, wherein the memory of the sensing and sound-emitting device is a computer memory and includes an active audio database which is prerecorded with plural sets of data of a sound emitted when the main portion moves in terms of tone, timbre and volume.

15. The interactive learning toy as claimed in claim 1I, wherein the memory of the sensing and sound-emitting device is a computer memory and includes a passive audio database, the passive audio database is pre-recorded with plural sets of data corresponding to the respective sensed devices in terms of tone, timbre and volume.

16. The interactive learning toy as claimed in claim 11, wherein the sensor is an antenna, the sensor is disposed on a front or a back surface of the main portion.

17. The interactive learning toy as claimed in claim 11, wherein the main portion is further provided with an ON/OFF switch.

18. The interactive learning toy as claimed in claim 11, wherein the sensed devices are divided into a timbre group and an object group, the timbre group includes a father device, a mother device, a baby device and a girl device that represent different timbres, the object group includes an apple device, a banana device, a carrot device and a cake device.

19. The interactive learning toy as claimed in claim 11, wherein the respective sensed devices include a memory and a sensor, wherein the memory of each of the sensed devices includes a database for recording identification data with respect to the sensed device profile meanings, the sensors of the sensed devices are connected to the memories of the respective sensed devices, so that the respective sensed devices will be powered on when it is sensed and activated by the sensor of the sensing and sound-emitting device to transmit the corresponding data to the sensor of the sensing and sounding-emitting device, and then the corresponding data will be processed by the center processor unit and finally played by the speaker.
